(19) United States
(12) Patent Application Publication
(10) Pub. No.: US 2012/0268771 A1
(43) Pub. Date: Oct. 25, 2012

(54) MULTI-FUNCTIONAL PRINTER DEVICE DISPLAYING FAULTED SHEETS

(75) Inventors: Peter KRUIZINGA, Venlo (NL); Matthijs F. MULLENDER, Seattle, WA (US)

(73) Assignee: OCE-TECHNOLOGIES B.V., Venlo (NL)

(21) Appl. No.: 13/475,474

(22) Filed: May 18, 2012

Related U.S. Application Data
(63) Continuation of application No. PCT/EP2010/068080, filed on Nov. 24, 2010.

(30) Foreign Application Priority Data
Nov. 25, 2009 (EP) 09177046.1

(51) Int. Cl. G06K 15/16; G06K 15/02

(52) U.S. Cl. 358/1.14

(57) ABSTRACT

An image processing apparatus has a control section, at least one sheet conveying system, at least one image conversion section and a user interface section having an associated display. The image conversion section includes a scanning function and/or a printing function, wherein the sheet conveying system is for conveying a sheet from an input section, past the image conversion section to an output section. In reaction to a paper jam in the sheet conveying system, resulting in sheets remaining in that conveying system after the same has come to a stop, the control section determines those sheets remaining in that conveying system, and shows thumbnail images thereof on the user interface display as an aid for an operator to remove those sheets. The last sheet correctly processed or the first sheet to be processed after clearance of the jam may be shown on the display.

The present invention relates to error recovery for sheet conveyance disturbances in a printer, scanner or multi-functional device.

More in particular, the present invention relates to an image processing apparatus having a control section, a sheet conveying system, an image conversion section and a user interface section having an associated display, wherein the image conversion section is for converting an optical image on a sheet into a digital image (scanning function) or converting a digital image into an optical image on a sheet (printing function), wherein the sheet conveying system is for conveying a sheet from an input section, past the image conversion section to an output section, wherein the control section is connected to the sheet conveying system, the image conversion section and the user interface section.

The invention also relates to a method of processing sheets implemented in the apparatus.

Sheet processing devices such as printers and scanners have a sheet conveying system wherein sheets (mostly paper sheets) are transported from one processing stage to another. Generally, conveying systems comprise a plurality of transport sections and are provided with sensors for following each sheet on its way through the device and signalling any malfunctions or paper jams in the transport immediately, so that the engine controller can take action, for instance by halting the sheet transport and shut-off of the processing sections until the malfunction has been cleared. Often times, when sheets are left in the sheet transport sections, a machine operator must open the device doors and one or more of the transport sections and take out any sheets stuck therein. Generally, the device controller provides the operator with instructions via the user interface panel display, advising where the sheets are located in the transport sections and how to remove them.

Various automatic diagnostic and jam recovery techniques have been developed for automatically checking how far the current job has proceeded and at which sheet of the set the job processing must be resumed in order to end up with a correct set of prints or, in case of a scanner, a correct set of digital document images.

US Patent Application No. US 2006/224559 discloses a printer device wherein upon a paper jam, the operator is advised of the device section wherein the jam occurred, and that, consequently, needs inspection and possibly operator intervention. In addition, a thumbnail image of the page that will be printed first when the job is resumed after the engine has been cleared, is displayed on the user interface panel of the device, together with neighboring page images. The operator may then check if he agrees and, if he disagrees, he may indicate another page image with which the job must be resumed.

EP 1 227 656 A discloses a printing system that is able to process so-called ordered media, e.g., Tab sheets. When a jam occurs, the controller determines which sheet of the set of ordered media is the correct one to recover to and shows a graphical representation of it on the user interface display.

Present-day recovery techniques are almost perfect, such that in almost all cases the produced set is correct without involvement of the operator other than the instructed removal operations.

Nevertheless, it has been found that operators do not always trust that the device controller has done a proper job, with the result that they will check the produced print-out or scan file for erratic pages and/or sometimes the already produced prints of the faulted job are simply thrown away and the job is started anew. Further, it is not impossible that a sheet that has been correctly printed and transported to the output section is nevertheless damaged or wrinkled, and if the operator sees so, he may also decide to start anew. This is undesirable, because it costs extra sheets and time.

Accordingly, it is an object of the present invention to provide a printer, scanner or multifunctional that provides the operator with an assessment of the situation and a recovery strategy as made by the engine controller after a paper jam and, if such is nevertheless deemed necessary, gives the operator an opportunity to intervene.

This object is achieved by providing an image processing apparatus according to the preamble wherein the control section is laid out for, in reaction to a paper jam in the sheet conveying system associated with any of the printing or scanning functions, resulting in sheets remaining in that conveying system after the same has come to a stop, determining those sheets remaining in that conveying system, and is also laid out for showing thumbnail images of those sheets remaining in the conveying system on the display as an aid for an operator to remove those sheets.

By inspecting the displayed images, so-called sheet thumbnails, and any sheets found in the apparatus, the operator can easily check if the output document will be correct. The content images make the sheets individually recognizable.

Clearing a paper jam often involves removing sheets that are stuck in one or more places in the conveying system. The operator may now look at the sheets he has removed and compare them with the ones shown on the display, and if they coincide, he will confidently restart the machine for finishing the job.

In an embodiment of the present invention, the last sheet correctly processed (printed or scanned) may be shown on the display after the jam has been cleared, so that the operator may check if the uppermost sheet in the output tray is indeed the one shown.

In another embodiment, in case of printing, the first sheet that will be printed when the printing is resumed after the jam clearance may be shown for the operator to check. This may be elaborated in giving the operator an opportunity to choose a different sheet, and also printing a check sheet.

In case of scanning, the last correctly scanned sheet may be shown on the display. The operator may then check if that sheet is indeed the one on top of the stack in the output tray.

In yet another embodiment, the first sheet to be scanned after jam clearance may be shown. Details of this embodiment are specified in the description hereinbelow.

Other inventive embodiments will be described hereinafter.

The invention will now be explained with reference to drawing, wherein:

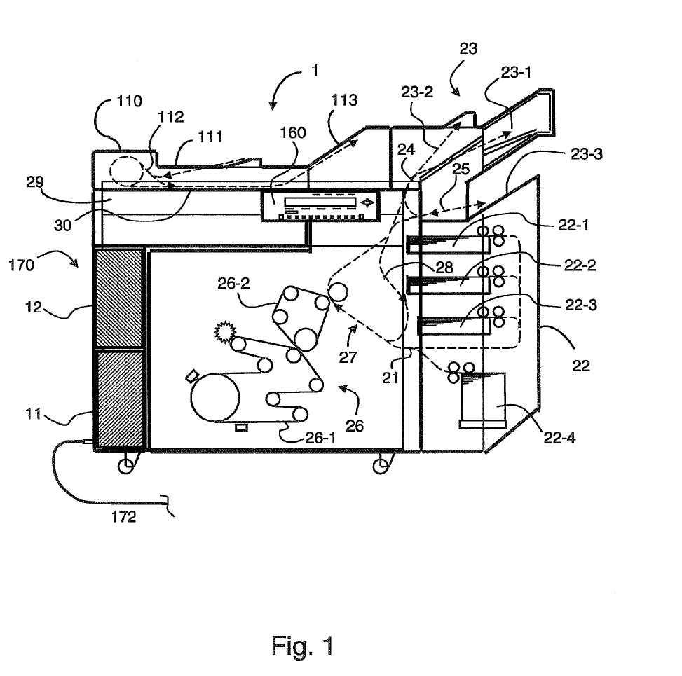

FIG. 1 shows a digital image reproduction device wherein the invention may be incorporated;

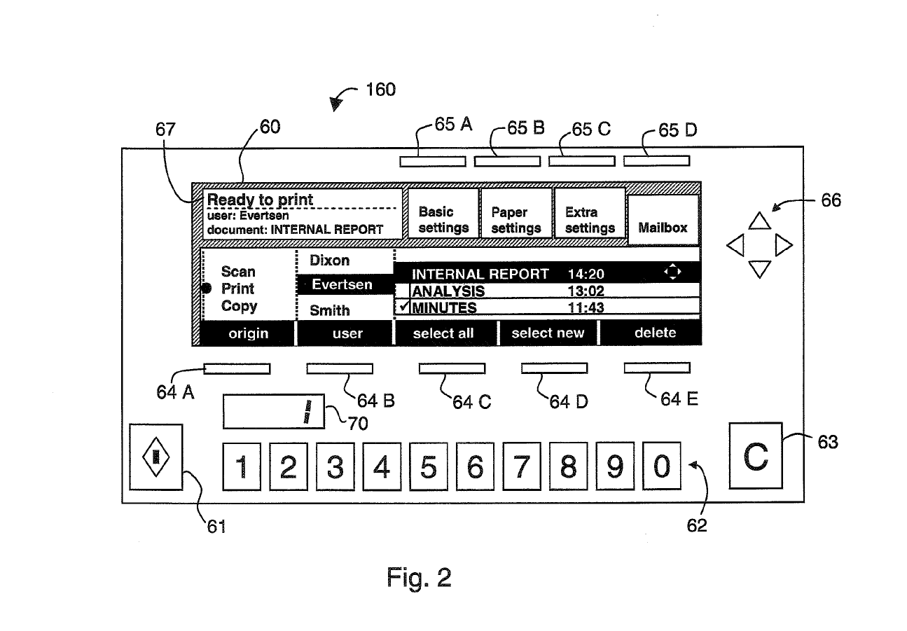

FIG. 2 shows an operator control panel belonging to the user interface section of the device of FIG. 1;

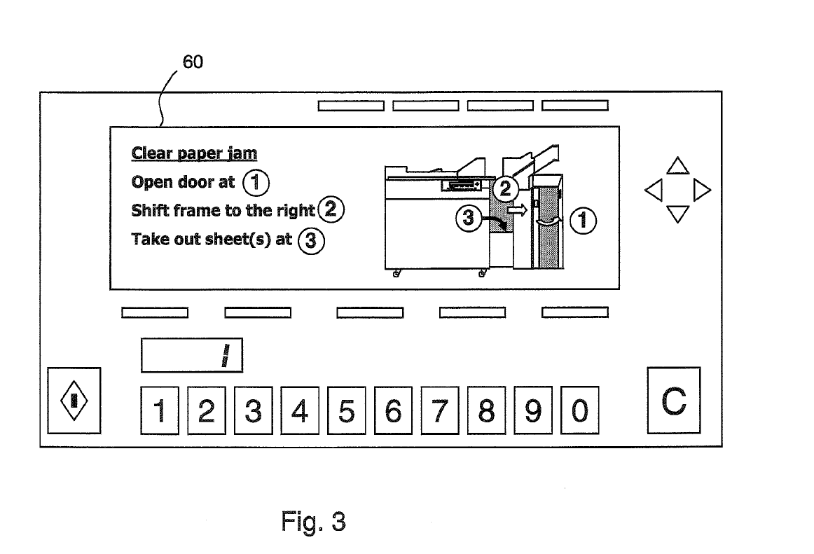

FIG. 3 shows the user interface display in case of a paper jam;

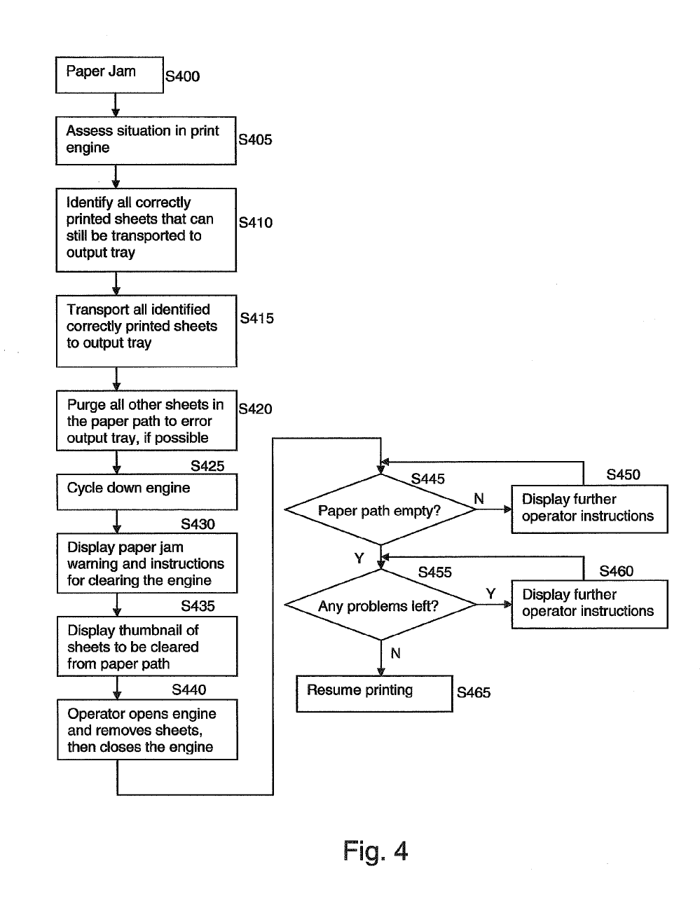

FIG. 4 is a flow chart explaining a first embodiment of the invention;

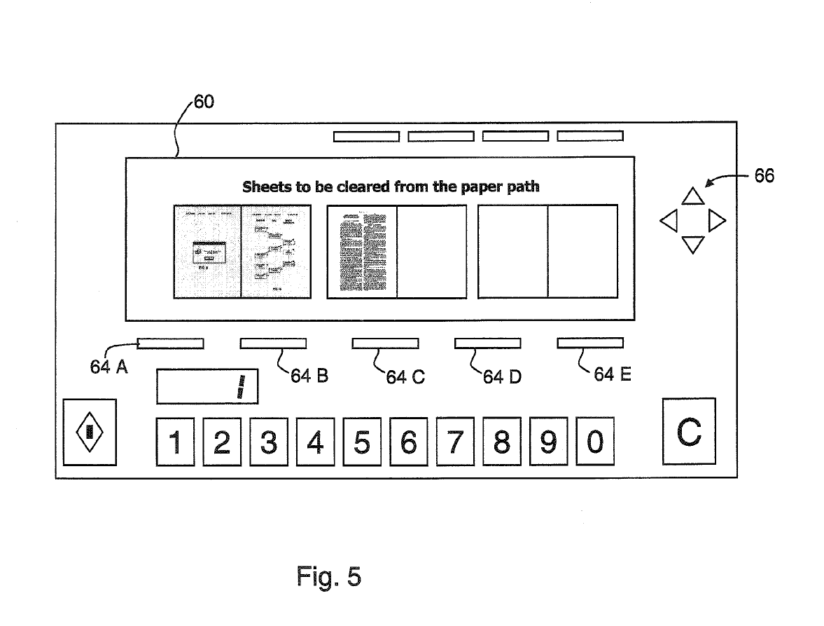

FIG. 5 is a display layout;

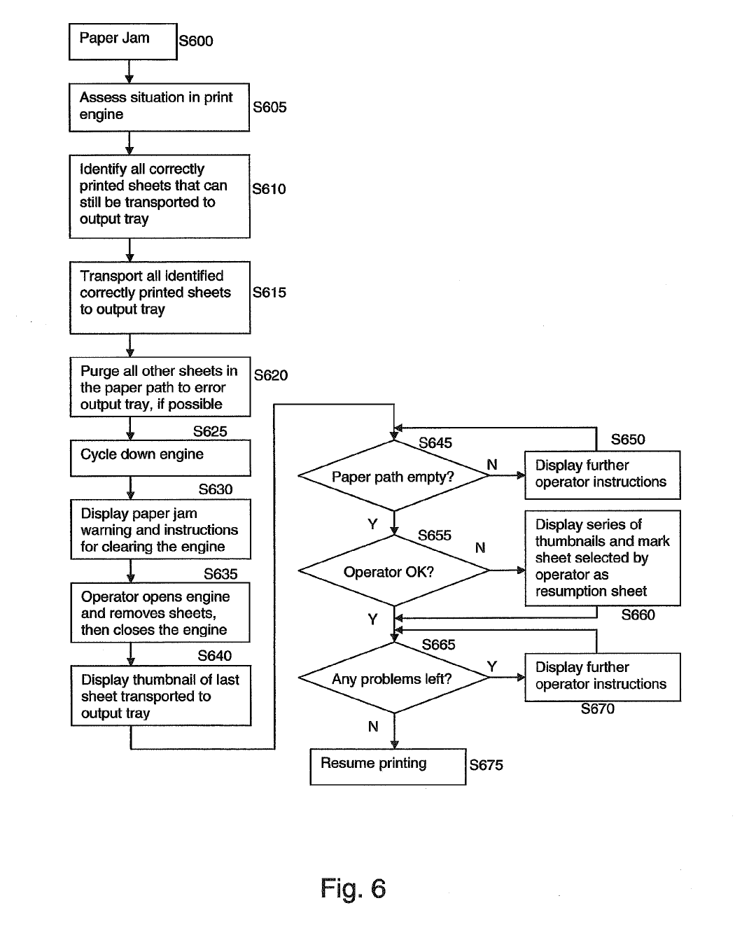

FIG. 6 is a flow chart explaining a second embodiment of the invention;

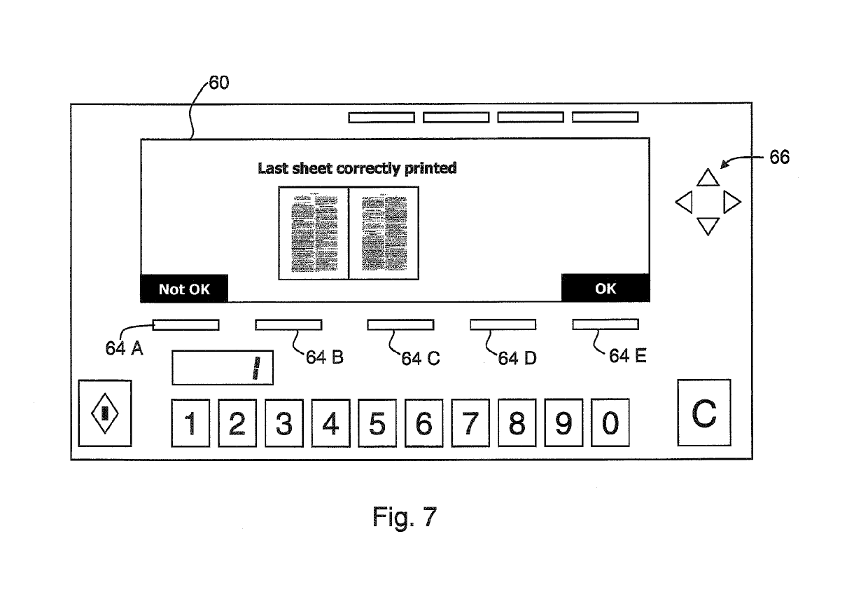

FIG. 7 is a display layout;

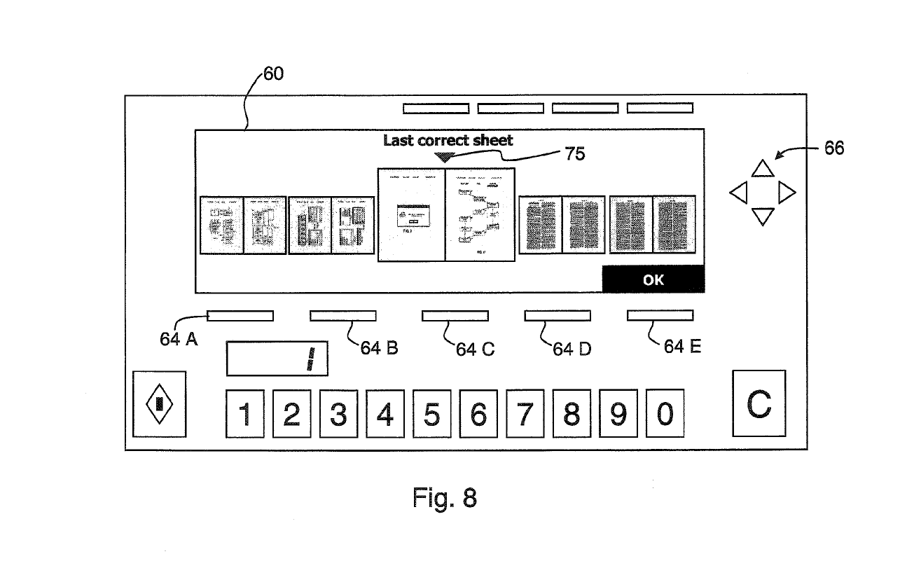

FIG. 8 is a display layout;

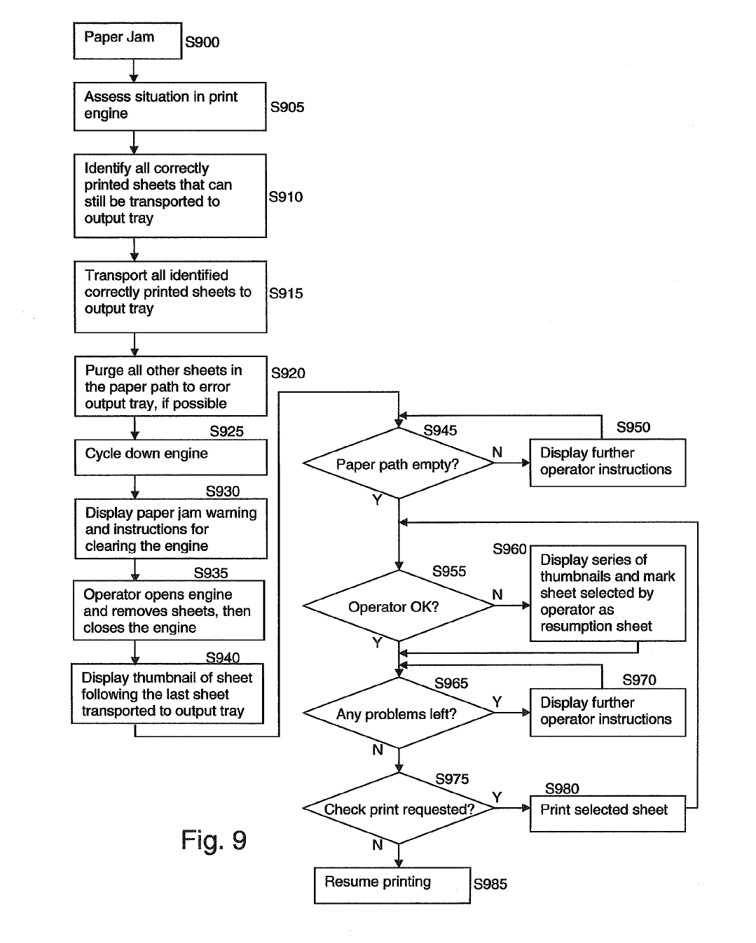

FIG. 9 is a flow chart explaining a third embodiment of the invention;

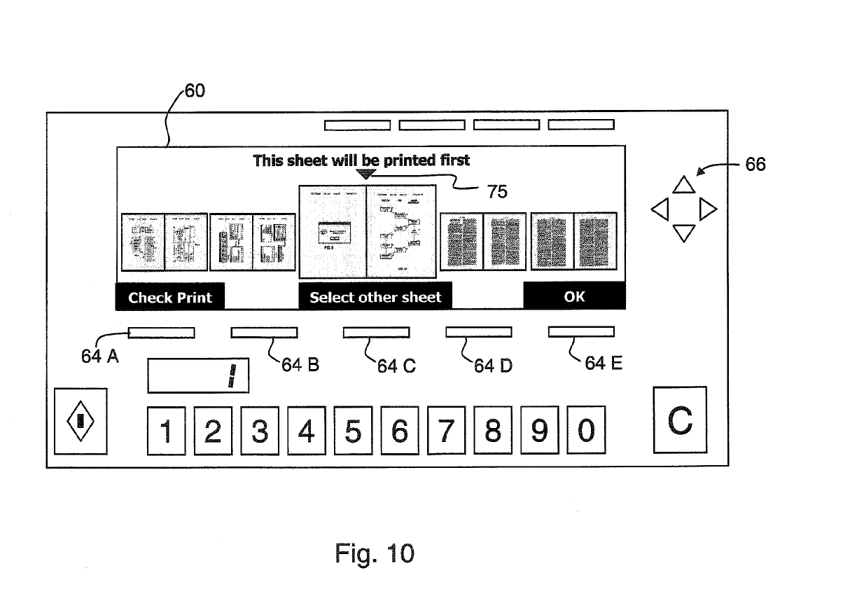

FIG. 10 is a display layout;

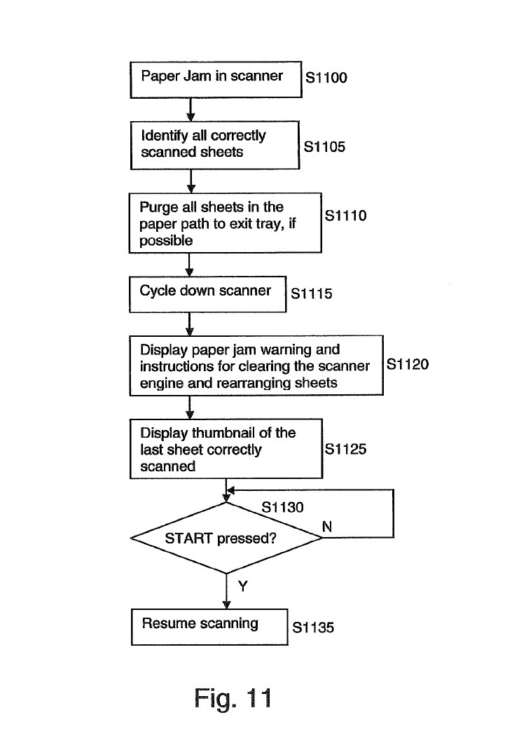

FIG. 11 is a flow chart explaining a scanning embodiment of the invention;

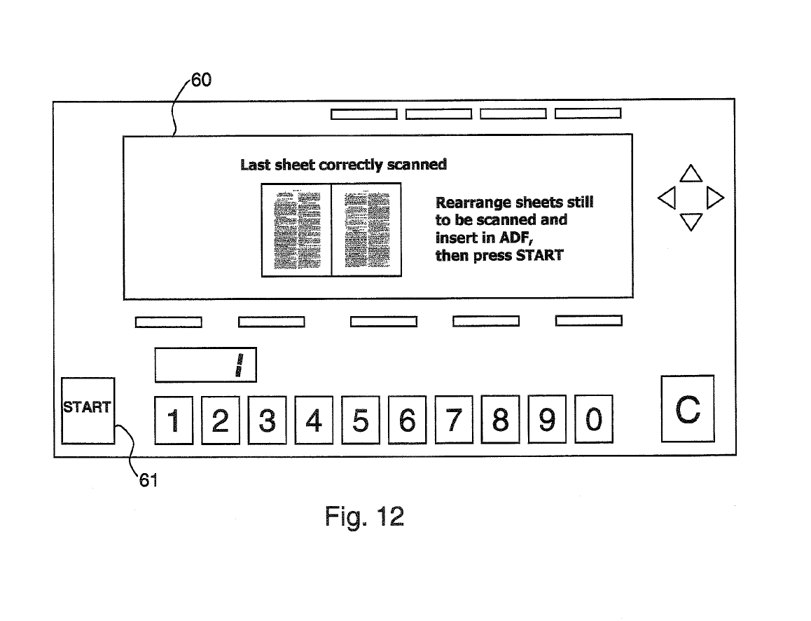

FIG. 12 is a display layout;

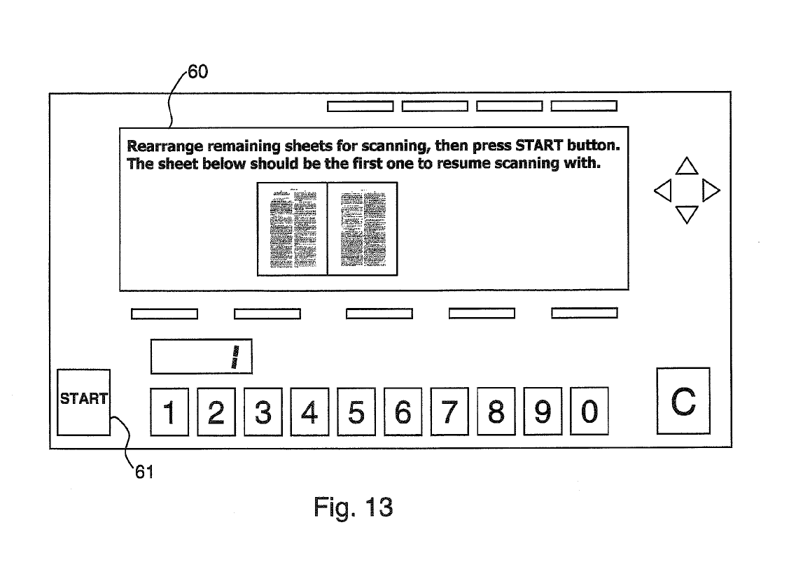

FIG. 13 is a display layout.

The Figures are diagrammatic and not drawn to scale. In the Figures, elements which correspond to elements already described have the same reference numerals.

FIG. 1 shows a digital image reproduction device 1, on which various parts are separately shown in diagram form. The documents to be processed are usually paper sheets, but may also include any other type of sheets for carrying information, e.g. overhead sheets, etc.

The device has a media stock unit 22 for providing sheets, which may have several trays 22-1, 22-2, 22-3, 22-4 containing sheets to be printed on, and an output unit 23 for receiving processed documents. The output unit 23 may comprise one or more output trays 23-1 and 23-2, and may include a finisher for sorting, stapling, and further processing of printed sheets. Furthermore there may be an extra output tray 23-3 for disposing faulted sheets.

The device has a printing system 26 which may include an electro-photographic processing section known per se, in which a photoconductive medium 26-1 is charged, exposed via an LED array in accordance with digital image data, and is developed with toner powder, whereafter the toner image is transferred and fixed on an image support sheet in a fuser system 26-2, while the sheet is being conveyed from the media stock unit 22 to the output unit 23 through a document conveying system 27.

Other image forming processes, e.g. a so-called direct imaging process, in which a toner image is directly formed onto a process drum that carries high-resolution electrodes, and then transferred to a fuser system for fixing onto an image support sheet, may also be contemplated.

The sheet conveying system 27 is for conveying the sheets from an input trajectory 21 at the media stock unit 22 to an output trajectory 24 at the output unit 23, along printing system 26. The sheet conveying system includes a reversing section 25 for reversing sheets, and a duplex return trajectory 28, for duplex treatment. As such, the printing system 26 and the conveying system 27, having various motors, rollers, guidance elements, belts, etc., are well known in the art of printing devices. Also, the entire sheet conveying system is provided with sensors at many places to enable control of all sheets being transported through it. The trajectories through the sheet conveying system will hereinafter also generally be called the “paper path”.

The device also includes a control section, shown diagrammatically by reference 170. A cable 172 may connect the control section 170 via a network interface to a local network. The network may be wired, but may also be partly or completely wireless. The control section 170 includes a controller 11 for, e.g., exchanging data files with the network environment and for scanning and printing, and an engine control unit 12 arranged for controlling the sheet conveying system 27 and printing system 26.

For example, the engine control unit 12 is connected with the motors, active guidance elements and sensors of the conveying system, and keeps track of all individual sheets at all times.

The device has a user interface 160, including an operator control panel provided on the apparatus for operation thereof. The user interface may be provided with a display and keys.

The digital image reproduction device may be a printer only, but preferably is a multi-functional device further including scanning, copying or faxing functions. An automatic document feeder (ADF) 110 is provided with an input tray 111 for the introduction of a stack of document sheets for scanning, a transport mechanism 112 for transporting the sheets one-by-one along a scanner unit 29 to an exit tray 113, in which the sheets are placed after scanning. The scanner unit 29 (not further elaborated in the drawing) includes a flat bed scanner provided with a glass platen 30 on which an original sheet can be placed, a CCD array and an imaging unit having a movable mirror and lens system for imaging the document sheet on the CCD array. In these conditions, the CCD array generates electrical signals which are converted into digital image data, also known as a scan file, in a manner known per se.

The transport mechanism 112 of the ADF 110 has various motors, rollers, guidance elements, belts, etc. as generally known in the art and is designed for double-sided scanning. Also, it is provided with sensors at many places to enable control of all sheets being transported through it. As in the printing system, the trajectories through the sheet transport mechanism 112 will hereinafter generally be called the “paper path”.

The operator control panel 160 belonging to the user interface section is shown in FIG. 2 and includes a display screen 60, such as an LCD display, and a number of keys, namely a start key 61, number keys 62, correction key 63 and selection keys 64A E, 65A-D and the key cluster 66.

When the apparatus has been switched on, the display screen 60 displays an image formed by a number of vertical columns, each situated above one of the selection keys 64A-E. Each column relates to a specific basic function of the apparatus and shows the different possible settings for that basic function. For example, the column over key 64A is allocated to the choice between a copying function, in which a document is scanned by the scanner and then reproduced, a printer function for interactive printing, in which a print is made from a data file received over the network and stored in the control unit 13, and a scanner function. The setting selected is indicated by a marker, such as a dark dot, or by highlighting.

By actuating a selection key an operator can choose a different setting, e.g. in accordance with a cyclic pattern. As a result of a change of a setting the function of one or more of the other selection keys may change, because the old function is no longer relevant and other selection options are required. Different text relating to the new function then appears in the associated column of the display screen 60.

The selection keys 65A-D offer the possibility of bringing up a different set of functions which cannot be displayed by the restricted dimensions of the display screen 60. These are generally functions which are not required for a simple copy or print job, but offer the operator more options to obtain special printing results. Key 65D is for showing any waiting print jobs received from the network. The meaning of the keys 65A-D is indicated in an associated field in the display screen 60 directly beneath each key. When one of the keys is actuated the corresponding set of functions is activated and the layout of the display screen 60 is adapted to the associated functions. At the same time, this selection is displayed by framing or otherwise making conspicuous that field on the display screen 60 which belongs to the actuated key of the group 65A-D. The operator control panel 160 also contains a number display 70 to indicate the number of prints set, as is generally customary on copying machines.

In FIG. 2, the display screen 60 is shown with a layout corresponding to the printer function. To arrive here, either key 64A (“Print”) or key 65D (“Mailbox”) has been actuated, whereafter key 64B has been used to select a user name (“Evertsen”) and key 64C has been used to select a print file (“Internal Report”) from a list of the files received from and stored for that user.

At that moment, key 64C changes function into selection of all files in the list, while the keys 64D and 64E are now for selecting all newly (i.e., after the last print action of that user) received print files and for deleting a selected file, respectively. The star keys 66 are for selecting individual print files in the list.

A section 67 on the display screen indicates the selected user name and print file. After selection of a file, the printing process is started by actuating the start key 61. When the printing process is started, digital images are converted to toner images in the printing system 26, while at the same time, sheets of receiving material are separated from one of the media stock trays in section 22 and transported by sheet conveying system 27 to the fuser system 26-2, where a toner image is transferred and fixed to each sheet.

Now, during the transport of the sheets, it may happen that one or more sheets get stuck in the conveying system 27 and obstruct further transport of sheets, resulting in a so-called paper jam. In that case, a human operator must intervene by opening the relevant parts of the machine and clearing the paper path. Also, any technically non-fatal obstruction may provoke a timing error in the control circuits, which may lead to a fault state and an automatic engine stop. Although all sheets are still in order, a manual intervention of the operator may be necessary before operation can be resumed. This will also be considered as a paper jam.

The engine control unit 12 may advertise the paper jam situation by a message through the user interface display 60, including instructions how to proceed in opening the machine and clearing out the sheets stuck therein, e.g., as shown in FIG. 3. In accordance with the present invention, the engine control unit may additionally show thumbnail images of sheets involved in the paper jam in order to help the operator to resolve the jam completely. Several embodiments of this inventive concept will be described hereinafter, as examples of possible implementations of the present invention.

In a first embodiment of the present invention, the engine control unit 12 is programmed to show thumbnails of those sheets that are stuck in the paper path and must all be removed by the operator. This makes life easier for the operator, because he simply has to check if the sheet(s) he has removed correspond to the images on the display. If, e.g., there is one more thumbnail displayed than he has sheets removed, then he immediately knows that there must still be another sheet he might have overlooked. Additionally, the displayed images give the operator the conviction that the engine controller precisely knows what sheets were involved in the jam, and that the eventual output set after resumption of the print job will be correct.

The implementation of a first embodiment above will now be explained with reference to the flow chart in FIG. 4.

The process starts when a paper jam takes place in the printer (S400). Then the engine control unit 12 assesses the situation in the print engine, to find out what exactly has happened and where all sheets are in the paper path (S405). In the process, it determines which sheets have been correctly printed and can still be transported to the output tray (S410), and then controls transport thereof to the current output tray 23-1 or 23-2 (S415). Also, it controls transport of sheets that have not correctly (c.q. not completely) been printed to the faulted prints tray 23-3, if possible (S420). The sections of the conveying system that are blocked by the stuck sheets are cycled down immediately to prevent further damage and the other sections as soon as possible after completing steps S415 and S420 (step S425).

In the meantime, a message for warning and advising the operator is composed and displayed on the display 60, for example, as shown in FIG. 3 (S430). This message includes instructions for the operator how to reach the stuck sheets and may also include a request to remove sheets from the faulted prints tray 23-3. By other sensors the engine control unit 12 is kept updated of the operations of the operator. When the engine control unit senses that the operator has reached the place where the sheets are stuck, it changes its display (S435) into one that shows thumbnails of the sheets that must be removed, as shown in FIG. 5. Other ways of displaying may be contemplated, such as, for example, alternating display of the screen layouts of FIG. 3 and FIG. 5.

In step S440, the operator opens the engine and removes the sheets from the paper path and the faulted prints tray, and may now compare those sheets with the thumbnails, and, if he is satisfied that they coincide, he may close the machine. The thumbnail images may show fully (e.g., both sides) printed or partially printed sheets, as can be seen in FIG. 5, because the sheets in the paper path may not have been printed yet. In FIG. 5, sheets are shown as adjacent rectangles for the front and back sides, respectively.

Next, the engine control unit 12 checks if the paper path is completely clear (S445) and if not, it displays additional instructions for the operator on the machine display 60 (S450), whereupon it again makes the check of step S445.

If the paper path is completely clear, the engine control unit 12 further checks if all systems are functioning well (S455). If not, it again displays additional instructions for the operator to remedy any existing fault states or, if such is not possible, seek advice or help from a service person (S460). If, on the other hand, everything is functioning well, the engine control unit automatically starts up the process section 26 and resumes the print process (S465).

In a second embodiment of the present invention, which may be combined with the first embodiment, the engine control unit 12 is programmed to show thumbnails of the last sheet that has correctly been printed and should therefore be found on top of the printed sheet stack in the output tray after the jam. Thus, the displayed image gives the operator the assurance that the engine controller 12 precisely knows where to restart the job to produce a correct output set.

The implementation of the second embodiment above will now be explained with reference to the flow chart in FIG. 6. Steps S600 till S630 fully correspond to steps S400 till S430 and will therefore not be explained here again. In the case that the first and second embodiments are combined, the step S630 corresponds to the combined steps S430 and S435, i.e., the display of the thumbnails of the sheets to be removed from the engine is part of the instructions for clearing the engine.

The operator may now remove the sheets stuck in the paper path and those in the faulted prints tray in accordance with the instructions on the display 60 (S635), and when the engine control unit 12 senses that the operator has removed the jammed sheets, it changes its display into one that shows a thumbnail of the sheet that is the last one that has been correctly printed and safely delivered to the output tray, as shown in FIG. 7 (S640). Then, the engine control unit 12 checks if the paper path is completely clear (S645) and if not, it displays additional instructions for the operator on the machine display 60 (S650), whereupon it again makes the check of step S645.

In the meantime, the operator may have opened the output tray and checked if the top sheet therein is indeed the one displayed as the “last one correctly printed”. If so, the operator actuates key 64E (“OK”), whereupon the engine control unit 12 further checks if all systems are functioning well (S665). If not, it again displays additional instructions for the operator to remedy any existing fault states or, if such is not possible, seek advice or help from a service person (S670). If, on the other hand, everything is functioning well, the engine control unit automatically starts up the process section 26 and resumes the print process (S675).

However, it may happen that in step S655 the operator finds that the top sheet in the output tray is not the same as displayed as the “last one correctly printed”, or he may find that the top sheet is damaged or otherwise unacceptable. In that case, he can actuate key 64A (“Not OK”), whereupon in step S660 the engine control unit 12 displays a series of thumbnails of sheets preceding an succeeding the currently selected one, wherein the currently selected one may be displayed larger, as shown in FIG. 8. The operator may now indicate another sheet as the “last one correctly printed”, by shifting an indicator 75 with the star keys 66 and confirming his choice with key 64E (“OK”). In reaction, the engine control unit 12 runs through steps S665, S670 (corresponding to steps S455 and S460) for engine inspection and S675, thereby finishing the print process.

In a third embodiment of the present invention, which may be combined with the first embodiment, the engine control unit 12 is programmed to show thumbnails of the first sheet that will be printed after the paper jam has been cleared, in other words, the sheet that follows on the last sheet correctly delivered to the output tray. The operator may then decide if he is happy with that selection or wants to change it. He may then order a check print of the newly selected sheet to be printed first and decide if it is according to his wishes.

The implementation of the third embodiment above will now be explained with reference to the flow chart in FIG. 9. Steps S900 till S970 fully correspond to steps S600 till S670, although some of the display images are different. Only the differences will be described below. In the case that the first and second embodiments are combined, the step S930 corresponds to the combined steps S430 and S435, i.e., the display of the thumbnails of the sheets to be removed from the engine is part of the instructions for clearing the engine.

As said, the display image shown in step S940 now indicates the first sheet that will be printed after the jam has been cleared, as shown in FIG. 10. The currently selected sheet is shown larger than the rest and is provided with an indicator 75. If the operator agrees with the indicated sheet, he may actuate key 64E (“OK”). If he disagrees, he may actuate key 64C (“Select other sheet”) and indicate another sheet to resume the print job with, by shifting the indicator 75 with the star keys 66 and confirming his choice with key 64E (“OK”).

In reaction, the engine control unit 12 runs through steps S965 and S970, corresponding to steps S665 and S670, in order to prepare for resuming the print job.

The operator may also want to check if the indicated sheet is indeed the one he wants. In that case, he may actuate key 64A (“Check Print”) in step S975, whereupon the sheet currently selected is printed and delivered to output tray 23-2 for easy inspection. If the operator is satisfied, he may actuate key 64E (“OK”), whereupon the print job is resumed with the currently selected first sheet to be printed (S985).

The present invention may also be applied to scanning, in stand-alone scanners or in multi-functionals, and in the latter case in combination with the second and third embodiments or not.

For scanning a multi-page document, an operator places the stack of original sheets in the input tray of the ADF 111 (FIG. 1), selects the scanner function with key 64A (FIG. 2) and starts the process with the start key 61. Then, the sheets of the document are separated from the stack and transported one-by-one past the scanner platen 30 by the transport mechanism 112 and, if necessary, turned and transported back to the platen for scanning the reverse side of each sheet.

During the transport of the sheets, it may happen that one or more sheets get stuck in the transport mechanism 112 and obstruct further transport of sheets, resulting in a paper jam. In that case, the operator must intervene by opening the relevant parts of the ADF and clearing the paper path. Also, any technically non-fatal obstruction may provoke a timing error in the control circuits, which may lead to a fault state and an automatic engine stop. Although all sheets are still in order, a manual intervention of the operator may be necessary before operation can be resumed. This leads to an unclear situation and will also be considered a paper jam.

The engine control unit 12 may advertise the paper jam situation by a message through the user interface display 60, including instructions how to proceed in opening the machine and clearing out the sheets stuck therein, analogous to the one shown in FIG. 3 for a paper jam in the print engine.

In accordance with the present invention, the engine control unit may now show thumbnail images of sheets involved in the paper jam in order to help the operator to resolve the jam completely. This greatly adds to the operator's comfort, since it is always quite unclear which sheets have completely been scanned and, accordingly, with which sheet the scan process must be resumed.

Two embodiments will now be described, as examples of implementation of the present invention. In the case of a multi-functional device (a printer/scanner combination), those embodiments may be combined with any of the first through third embodiments hereinabove.

A fourth embodiment of the present invention, related to the scanner, will now be explained with reference to FIG. 11.

The process starts when a paper jam takes place in the scanner (S1100). Generally this will mean that part of the document sheets have already been scanned and transported to the exit tray 113, while one or more sheets are in the paper path of the transport mechanism 112, and the rest of the sheets are still contained in the input tray 111. When it finds out about the paper jam, the engine control unit 12 assesses the situation in the ADF to find out what exactly has happened, where all sheets are in the paper path and which sheets have already been safely scanned and entered in the exit tray (S1105). Next, it controls transport of the sheets in the paper path to the exit tray, if such is possible (S1110) and brings the transport mechanism to a stop (S1115).

In the meantime, a message for warning and advising the operator is composed and displayed on the display 60. This message includes instructions for the operator how to reach the stuck sheets (S1120). By other sensors the engine control unit 12 is kept updated of the operations of the operator. When the engine control unit senses that the operator has cleared the jam, it changes its display (S1125) into one that shows a thumbnail of the last sheet that was correctly scanned and stored and instructions for rearranging the sheets that still have to be scanned, as shown in FIG. 13.

Then, the engine control unit waits for the operator to arrange the sheets in the ADF and actuate the start key 61 (S1130), whereupon it resumes the scanning process (S1135), appending the scan data to the file generated before the paper jam.

In a slightly different embodiment an advice is displayed for the operator, showing a thumbnail of the sheet that is to be scanned first when the scan process is resumed and should therefore be placed on top of the stack of yet unscanned sheets. A corresponding display image is shown in FIG. 13. This has the advantage that the operator only has to concentrate on the stack of sheets he has to put in the input tray. In fact, it is not possible to display the first unscanned or incompletely scanned sheet, since no image thereof has been generated yet. Therefore, a thumbnail of the last completely scanned sheet is shown and the scanned image of that sheet is deleted from the scan file, so that when it is scanned again, the scan file will be complete and contains no doubles.

It is also possible to give the operator an opportunity to choose another one of the already scanned sheets as a starting sheet for the resumed scanning, for whatever reason that moves him. This may be implemented in a way analogous to the one described in relation to FIG. 10, with the difference, that only previously scanned sheets can be shown on the display. If the operator selects another sheet, the scan files associated with the sheets to be scanned again will first be deleted before the scanning is resumed.

In all embodiments above, the sheet thumbnails displayed on the user interface display may be shown with an enlarged page number superimposed on the content image. The page number may be determined by an automatic analysis of the print image, known per se. Page numbers are generally placed in any one of a limited number of positions, so, provided that they are present, finding and recognizing them is not difficult. The page numbers may help the operator in recognizing the sheets, especially in case of an all-text document, the pages of which may closely resemble each other.

While the invention has been explained in the form of the above embodiments, it will be clear to the skilled person that other embodiments are possible within the scope of the appended claims, the latter being the only limit to the protection of the patent.

1. An image processing apparatus comprising a control section, at least one sheet conveying system, at least one image conversion section and a user interface section having an associated display,
wherein the image conversion section is for converting an optical image on a sheet into a digital image (scanning function) or converting a digital image into an optical image on a sheet (printing function),
wherein the sheet conveying system is for conveying a sheet from an input section, past the image conversion section to an output section,
wherein the control section is connected to the sheet conveying system, the image conversion section and the user interface section, and
wherein the control section is laid out for, in reaction to a paper jam in the sheet conveying system associated with any of the printing or scanning functions, resulting in sheets remaining in that conveying system after the same has come to a stop, determining those sheets remaining in that conveying system, and is also laid out for showing thumbnail images of those sheets remaining in the conveying system on the display as an aid for an operator to remove those sheets.

2. The image processing apparatus of claim 1, wherein the control section is laid out for, in reaction to a paper jam in the sheet conveying system associated with the printing function,
determining the last sheet that was correctly processed and conveyed to the output section and showing on the display a thumbnail image of that sheet, and
preparing to initiate a resumed processing action with the image for the sheet following said last sheet that was correctly processed and conveyed.

3. The image processing apparatus of claim 1, wherein the control section is laid out for, in reaction to a paper jam in the sheet conveying system associated with the printing function,
determining a sheet that will be printed first after the jam has been cleared and showing a thumbnail image of that sheet on the display, and
preparing to initiate a resumed processing action with the image for that sheet.

4. The image processing apparatus of claim 1, wherein the control section is laid out for, in reaction to a paper jam in the sheet conveying system associated with the scanning function,
determining a sheet that must be scanned first after the jam has been cleared, based on an image that has been scanned correctly before the jam took place, and showing a thumbnail image of that sheet on the display, as an aid to arrange a sheet sub-set for a resumed scanning action, and
preparing to resume the scanning and to append the scan files generated therein to the scan file generated during the scanning before the disturbance took place, while preventing doubles.

5. The image processing apparatus of claim 2, wherein the control section is laid out for receiving a command from the user interface indicating a different sheet than the sheet shown on the display.

6. The image processing apparatus of claim 5, wherein the control section shows a set of images of neighboring sheets on the display of the user interface, for an operator to choose from.

7. A method of processing sheets in an image processing apparatus for printing and/or scanning sheets, the apparatus having a control section, a sheet conveying system for conveying a sheet from an input section, past the image conversion section to an output section, an image conversion section and a user interface section having an associated display, wherein the image conversion section is for converting an optical image on a sheet into a digital image (scanning function) or converting a digital image into an optical image on a sheet (printing function),
said method comprising the steps of:
in reaction to a paper jam in the sheet conveying system associated with any of the printing or scanning functions, resulting in sheets remaining in the conveying system after the same has come to a stop, determining those sheets remaining in the conveying system, and
showing on the display thumbnail images of those sheets remaining in the conveying system as an aid for an operator to remove those sheets.

8. The method of claim 7, including, in reaction to a paper jam in the sheet conveying system associated with the printing function,
determining the last sheet that was correctly processed and conveyed to the output section and showing on the display a thumbnail image of that sheet, and
preparing to initiate a resumed processing action with the image for the sheet following said last sheet that was correctly processed and conveyed.

9. The method of claim 7, including, in reaction to a paper jam in the sheet conveying system associated with the printing function,
determining a sheet that will be printed first after the jam has been cleared and showing a thumbnail image of that sheet on the display, and
preparing to initiate a resumed processing action with the image for that sheet.

10. The method of claim 7, further comprising, in reaction to a paper jam in the sheet conveying system associated with the scanning function,
determining a sheet that must be scanned first after the jam has been cleared, based on an image that has been scanned correctly before the jam took place, and showing a thumbnail image of that sheet on the display, as an aid to arrange a sheet sub-set for a resumed scanning action, and
preparing to resume the scanning and to append the scan files generated therein to the scan file generated during the scanning before the disturbance took place, while preventing doubles.

11. The method of claim 8, further comprising enabling an operator to indicate a different sheet than the sheet shown on the display.

12. The method of claim 11, further comprising showing on the display a set of images of neighboring sheets, for the operator to choose from.

13. The image processing apparatus of claim 2, wherein the control section is laid out for, in reaction to a paper jam in the sheet conveying system associated with the scanning function,
determining a sheet that must be scanned first after the jam has been cleared, based on an image that has been scanned correctly before the jam took place, and showing a thumbnail image of that sheet on the display, as an aid to arrange a sheet sub-set for a resumed scanning action, and
preparing to resume the scanning and to append the scan files generated therein to the scan file generated during the scanning before the disturbance took place, while preventing doubles.

14. The image processing apparatus of claim 3, wherein the control section is laid out for, in reaction to a paper jam in the sheet conveying system associated with the scanning function,
determining a sheet that must be scanned first after the jam has been cleared, based on an image that has been scanned correctly before the jam took place, and showing a thumbnail image of that sheet on the display, as an aid to arrange a sheet sub-set for a resumed scanning action, and
preparing to resume the scanning and to append the scan files generated therein to the scan file generated during the scanning before the disturbance took place, while preventing doubles.

15. The image processing apparatus of claim 3, wherein the control section is laid out for receiving a command from the user interface indicating a different sheet than the sheet shown on the display

16. The image processing apparatus of claim 4, wherein the control section is laid out for receiving a command from the user interface indicating a different sheet than the sheet shown on the display

17. The method of claim 8, further comprising, in reaction to a paper jam in the sheet conveying system associated with the scanning function,
determining a sheet that must be scanned first after the jam has been cleared, based on an image that has been scanned correctly before the jam took place, and showing a thumbnail image of that sheet on the display, as an aid to arrange a sheet sub-set for a resumed scanning action, and
preparing to resume the scanning and to append the scan files generated therein to the scan file generated during the scanning before the disturbance took place, while preventing doubles.

18. The method of claim 9, further comprising, in reaction to a paper jam in the sheet conveying system associated with the scanning function,
determining a sheet that must be scanned first after the jam has been cleared, based on an image that has been scanned correctly before the jam took place, and showing a thumbnail image of that sheet on the display, as an aid to arrange a sheet sub-set for a resumed scanning action, and
preparing to resume the scanning and to append the scan files generated therein to the scan file generated during the scanning before the disturbance took place, while preventing doubles.

19. The method of claim 9, further comprising enabling an operator to indicate a different sheet than the sheet shown on the display.

20. The method of claim 10, further comprising enabling an operator to indicate a different sheet than the sheet shown on the display.
